(19) United States
(12) Patent Application Publication
(10) Pub. No.: US 2018/0023991 A1
(43) Pub. Date: Jan. 25, 2018

(54) Dual purpose measuring and dispensing device

(71) Applicant: Abbas Ben Afshari, Lexington, KY (US)

(72) Inventor: Abbas Ben Afshari, Lexington, KY (US)

(21) Appl. No.: 15/214,418

(22) Filed: Jul. 19, 2016

(51) Int. Cl. G01F 19/00

(52) U.S. Cl. CPC G01F 19/00

(57) ABSTRACT

A dual purpose gravity flow measuring and dispensing device for flowing matters such as sauces, oily substances, medical solutions, food flavorings or chemicals, comprising of a feature to measure the flowing matter 2 times prior to final application, contamination free and accurately. The device can be constructed for fluids or powders, a preferred embodiment includes a plate that's is coupled to 2 container each on top and bottom of the plate, an outlet directly on the lower container or part of the plate, the plate can be constructed to be a cap for the lower container. The upper containers can be integrated onto upper portion of the plate and a channel in between the 2 containers, a valve to controlled the flow of fluids running from upper container to the lower container and an automatic airflow system to allow the air to enters above the flowing matter when the valve is open. This system is also is used for adding a precise amount of flowing matter from the upper container to the lower container mix it with and dispense it, the valve is a mechanical valve that requires a force to open, the valve can be biased for automatic shutting upon releasing the pressure exerted from an outside source for it's opening.

### FIELD OF INVENTION

This invention has 2 objections; 1^{st} is to generally measure a flowing matter and dispense it with confident that the amount to be dispensed is measured precisely 2 times, once by measuring marks from a 1^{st} container to a 2^{nd} container, and 2^{nd} from the 2^{nd} container to a final destination. This means an operator has a chance to double check the amount prior to its final placement within one device, This measuring and dispensing applies to food fluids such as sauces and flavorings, liquid chemicals, 2 cycle oil and or food recopies. 2^{nd} objections of the invention allows for precisely adding a 1^{st} flowing matter to another one, especially for mixing a heavy capsaicin fluid to a sauce prior to serving it, or precisely adding a chemical compound to another, or for adding and mixing hair products, chemical compounds pharmaceutical compounds, gasoline applications and food flavorings, this invention applies to variety of sizes, for example for a measuring and mixing device on a key chain.

### BACKGROUND OF THE INVENTION

There are many liquids food such as sauces that consumers purchase but the taste is not exactly what they want, there are also many chemical compounds, and flavorings that need to get measured precisely and added to another compounds without contaminating the 1^{st} compound or endangering the operator during mixing or measuring, some pepper extracts are extremely irritating to skin and eyes and small measured amount is required to make a sauce or food hot, too much of such extract will increase the capsaicin level of sauces to extreme and some time too little will not taste hot enough. The hot sauce market is in it's explosion and increasing, reports indicates that this segment is number 8^{th} fastest growing segment in the country. The food craze is out bounding and many millennial people are open to purchasing a liquid product that can make their food tastier or their usage easier for such change of flavoring, but the liquid and powder flavorings and chemical compounds are now only available in a bottles or a container with a cap, the consumers must remove the cap and pour the content in measuring cups prior usage or rely on a marks on the containers with a bottle neck, again this method requires tipping the bottle for the content to pour out, this method is not accurate and poses contamination and in some cases irritant to eyes and skin.

Today 2 cycle oils are offered for sale in a large bottle with readout on the side and a cap, one can open the cap and pour specific amount inside a gas container, these style of measurement are not user friendly, inaccurate and inconvenient, there are also 2 cycle oils in small one time use for 1 gallon tanks, after pouring the content in the tank one must dispose of the empty 2 cycle bottle which is bad for environment, in prior arts there has been some gas containers introduced that a container of 2 cycle oil is inside of a gas tank, this method isn't user friendly and occupies the internal volume of the tank, meaning one cant fill the tank to it's final capacity prior to mixing since, the vacuum created around the internal container doesn't allow introduction of the 2 cycle oil to the gas container.

There are many measuring cups to measure liquid and powder, add flavoring or oil to foods or for mixing chemical compounds but non are user friendly convenient, safe and non irritating and spill free at once, meaning measuring cups are to measure and pour in a open container, if one uses a conventional measuring cup and introducing contaminant or hazardous gasses or liquids in the process or chance of spilling such liquids is extremely high.

There has been many containers that liquid or powder products are sold, again, such containers of such products have a cap that one must open and manually pour the liquid or powder inside a measuring cup for adding to another liquid or powder. For example when a cup or a table spoon of oil should be used, one must open the cap of the container and pour it inside a table spoon and then pour the table spoon oil in a mixture of cake. The enclosed invention is simple container that eliminates the need for spoon and or a separate measuring cup, since a new point of sale package will hold the oil on the top and the measuring cup on the bottom after purchase, the consumer simply open a valve and allows the oil or vinegar or any other fluid to pour to the bottom container and then pour it in the food. If the consumer wants the can refill the upper container and repeat this operation.

Another body of the enclosed invention is a simple closed container with a valve at it's bottom end and an airflow system that doesn't require opening a top cap for air flow, meaning when the valve is open the same time air flows automatically above the liquid for vacuumed elimination and proper flow of such liquids.

Prior arts also includes drinking bottles to add flavoring to a water bottle with a spout or an outlet to dispense the mixture an example is a product made by Cool Gear Inc. (Application # 20120061421) in this system the lower unit a is bottle made for water and a compartment is coupled to the inside of the cap, this compartment has a closure that also is a plunger, at the lower portion of this compartment is a rubber valve that is not continuously open but is continuously closed, upon pressing on the plunger the rubber valve opens and flavoring injects in the water, The problem with this system is that it cant be used as a measuring cup, and it cant be used for thick fluid mixture and cant be used for powder like flowing matters. These flavorings are not measurable the plunger only has a fixed, Metered amount of flavoring to add to the liquid with one plunge without a control mechanism.

The plunger type systems such as the one by cool gear is not suitable for precisely adding a flowing matter to another or precisely measuring a flowing matter singularly, it is intended to inject flavoring without knowing how much is injected and based on metered amount that cant be controlled, since higher pressure will emit more than needed in the lower container with water. Another prior art is U.S. Pat. No. 6,705,491 includes a cap that holds flavoring, one can add flavoring thru a compartment inside a drinking vessel, but no way for knowing how much, also flavored water dispenses thru the same flavoring compartment meaning the outlet depends on the 1^{st} compartment.

Therefore there is a need for a measurement tool that can measure certain amount of extract or chemicals without contaminating it, reduce or totally eliminate physical harms or simply adding a measured amount of liquid or powder to another, or measuring a compound itself and to protect the compound in a 2ndry container prior to final adding step. In our claimed invention the 2^{nd} container is unlimited in size, since it is located on the outside of the 1^{st} container.

The enclosed invention is novel since it has dual usage, 1^{st} is to measure and add flowing matters without contamination, and 2^{nd} is to mix a measured amount to another flowing matter for concluding a new compound from the mix and then pour it out without contaminating the 1^{st} compound.

### SUMMARY OF THE INVENTION

It is the object of the invention to provide a device that can precisely measure and dispense certain amount of liquid that is stored in a container and to operate such task in a hand held device without transferring such stored liquid to another measuring device with the least probability of spilling.

It is a further object of this invention to mix 2 flowing matters and dispense it without contamination from external matters and without using a third device to make the transfer of such flowing matter.

It is a further object of this invention to have a device that doesn't use a plunger to add flavor to a food fluid and that this device includes a reliable valve that completely keeps the flavor from the fluid upon extreme shaking.

It is a further object of this invention to provide a device that can become an enclosure to another container and have the capability to house all necessary components on its outside to perform the task of measuring, dispensing and allowing air to enter above such fluid for flow of such fluid flow without breaking a seal or opening a cap of a container holding such fluid.

It is a further object of this invention to provide a device that reduces or eliminates irritation to skin and eyes for adding high capsaicin holding liquids to a food or to a sauce and mix it prior to dispensing it.

It is a further object of this invention to mix chemicals for hair coloring and other chemically interactive together without irritating or getting color all over the hands or surroundings.

It is further object of this invention to have device that an operator can easily operate with one hand.

It is further objective of this invention to have a completely sealed container that still allows a certain amount of air enter inside the container above it's fluid level when it is needed for dispensing without breaking the seal at it's enclosure for air flow.

We have met these objectives by providing a device that is hand held and provides convenient, can get sold with a fluid from a business establishment for one time use, or a device that can be refilled by the consumer for multiple usage.

### BRIEF DESCRIPTION OF DRAWINGS

In order to better demonstrate the benefits of the enclosed invention FIG. 1 and FIG. 2 and FIG. 3 are 3 examples of preferred embodiments, the preferred embodiments are not by any means a limitation to the claims of enclosed invention.

FIG. 1 is a preferred embodiment where 1^{st} container 1 has the enclosure 6, the inside wall 4, outside wall 5, the enclosure 6 has the inside 2 and outside 3, the enclosure 6 further has 1^{st} channel opening of 12 for the fluids or powder 11 to flow 28 from inside of the 2^{nd} container 8, and a 2nd channel opening 19 to allow air to enter above the fluid or powder 11 of the 2^{nd} container 8 thru the pipe 32 from it's end 31, the 2^{nd} container 8 includes inside walls 9 and outside walls 10, having a fluid or powder 11 and is coupled at it's base 7 to the enclosure 6, the channels 12 and 19 are tapered to accept tapered plugs 13 and 20, tapered plugs 13 and 20 are connected with the bridge 18 and both are connected to the plug 16 with the bridge 18, which is plugging the 3^{rd} channel 17 located on the enclosure 6, plug 16 is then coupled with the set screw 24, set screw 24 then is coupled with the push button 25, enclosure 6 incorporates a blind circular channel 22 around the channel 16, the push button 25 has a hollow inside creating walls 37 for the biasing member 23 which is a compression spring 23, compression spring 23 pushes against the push button 25 and enclosure 6 causing the plugs 20 and 13 to cut the flow of air and flowing matters from channels 19 and 12, but when a force 27 is exerted upon the bush button 25 and the force 27 is greater than the force of spring 23 the force 27 pushes the push button 25 downward while the walls of the push button 25 enters within the circular channel 22, the plug 17 moves downward and since is connected with the bridge 18 to the plugs 13 and 20, plugs 13 and 20 get pushed away from the channels 12 and 19 and the air will flow inside and above the fluid or powder matters 14 in the 2^{nd} container 8, the vacuum above the fluid or powder 14 then releases and the fluid or powder will flow out 28 of the channel 12, and when the force 27 is released, the flow 28 stops by the force of the spring 23 pushing all plugs 17,18 and 20 up ward 26, and when the container 1 is tipped, the fluid or powder 14 pours out of the 1^{st} container 1 thru the opening 14, the 2^{nd} container 8 incorporates threaded neck 29 and a cap that looks like a fedora hat that seals the 2^{nd} container 8 with the mating thread 30 to interact with thread 29, 2^{nd} container 8 has measuring marks 35 and 1^{st} container 1 has measuring marks 36, 1^{st} container 1 also can includes a 2^{nd} fluid or powder and a mixture of 1^{st} and 2^{nd} fluid or powder 39 and 21 flow out from the outlet 14 and the funnel of 37 of the outlet 14, a cap that looks like a fedora hat 38 encloses the 2^{nd} container 11. If the mixture 21 is slow flowing, the 1^{st} container 1 can be a squeezable bottle.

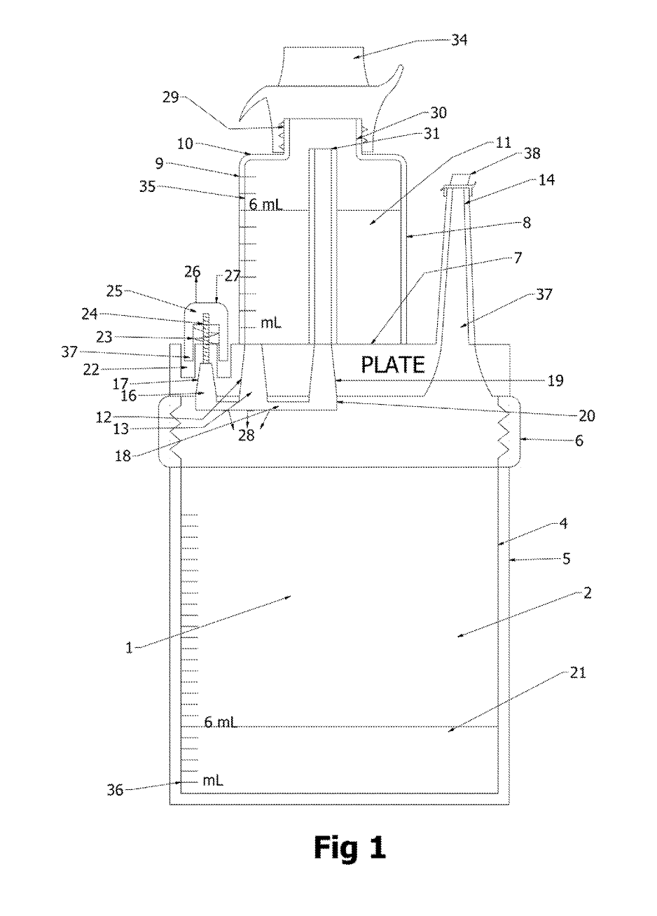

FIG. 2 is another preferred embodiment having a 1^{st} container 101 inside walls 104 and outside walls 103 having the enclosure 110 and the outlet 113, the enclosure 110 includes a thread 111 to mate with the thread from the 1^{st} container 101 with the thread 112, a channel 108 for flow of fluid or powder and channel 117 for flow of air, the ball valves 122 and 121 that include channels 108 and 119 are in-line with the channels 107 and 117, the knob 120 controls the pivoting action for the ball valves 122 and 121 at once for the air to flow above the fluid or powder inside of the container 102 incorporating inside walls 105 and outside walls 106, container 102 is installed outside of the enclosure and above the container 101, and the fluids or powder 109 flows from inside the container 101 to outside of 1^{st} container 101, when tipping the container 101 toward the outlet 113, therefore all or a portion of the fluid 109 which is transferred inside the container 101 exits from the container 101, and if another fluid or powder 123 is in the 1^{st} container 101 a mixture of 123 and 109 can get poured out of the container 101 from the outlet 113 at once.

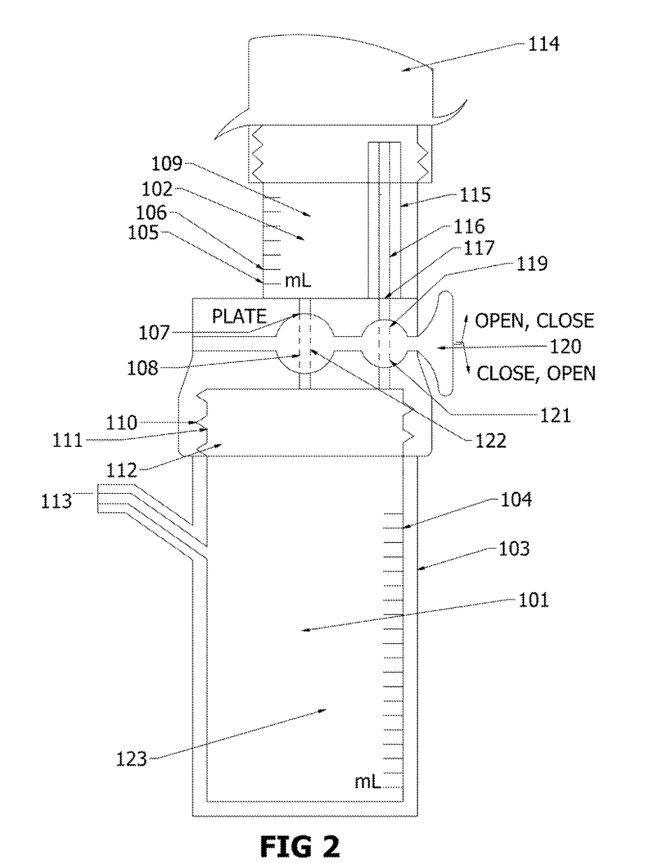

FIG. 3 is another proffered embodiment that is not coupled to any lower container, where container 200 includes a cap 202 and fluid flavoring 201 with a valve 203 with continuous open 209 and continuous closed 208, the tube 207 is coupled to lower portion of the container 200 and when valve 204 is in open position 209, the air flows above the fluid flavoring 201 and in the same time the fluid 201 flows out of the channel 206 and thru the valve channel 210.

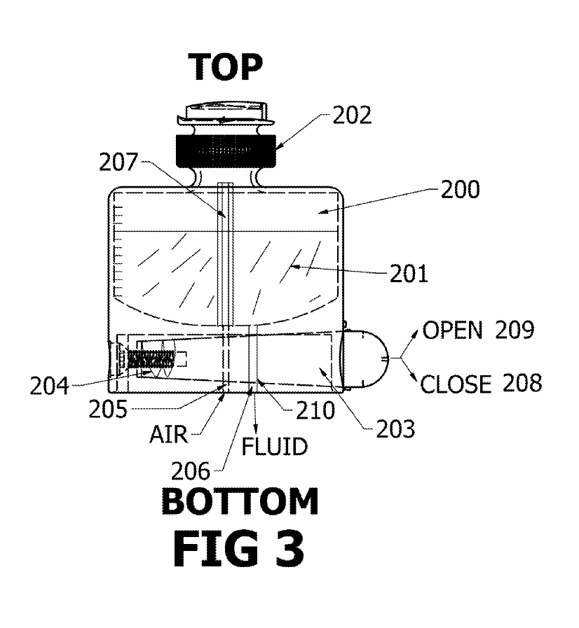

FIG. 4 is another proffered embodiment where the 1^{st} container 401 includes gas 410 and outlet 406 and threaded neck 404 and a 2^{nd} container 402 having 2 cycle oil 411 and the valve 405, the valve 405 includes 2 ball valve and when the valve 405 is in open position the ball valve 409 allows air above the 2 cycle oil thru the pipe 408 and valve 403 allows 2 cycle oil 411 flow inside of the container 401, if necessary, the cap 407 can be opened to allow air in or refill 2 cycle oil 411 while the valve 405 is in closed position, the cap 411 can keep open when the valve 405 is in open position for air flow as well.

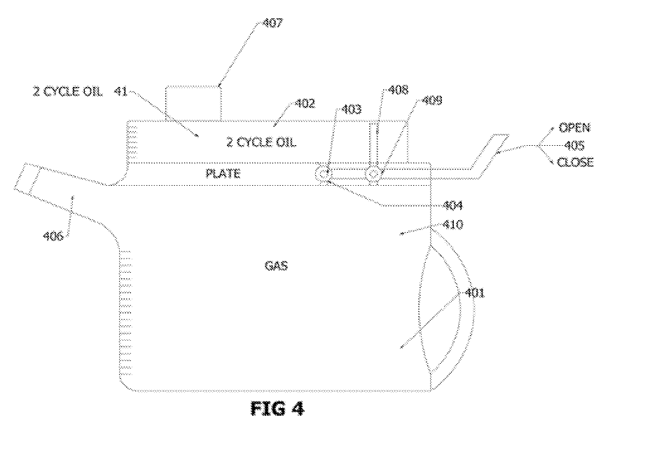

FIG. 5 is another proffered embodiment where 1^{st} container 302 is coupled to lower portion of the plate 303 and 2^{nd} container 301 is coupled to upper portion of the plate 303, the tapered channel 309 houses the valve 314 which is biased with spring 307 to press against inside walls of the channel 309, the valve 314 includes the extension 316, the tapered channel 304 houses the valve 315, the valve 315 includes extension 317, the container 301 include fluids 318, the valve 315 is biased with the spring 308 and the extension 317 is coupled to the button 309 and when the force 319 applied to the button 309, the extension 317 moves down and pushes against the extension 316 and moves the valve 314 allowing fluid 318 to flow inside of the 1^{st} container 302. At this time air flows from around the valve 315 inside of the container 301 and above the fluid 318. And when the device is leaned toward the outlet 305 and when the cap of 306 is of the 305, the fluid 301 that is now inside the 302 pours out of the outlet 305, this device can get made small enough to have a chain 311 and the ring 312 for the key 313.

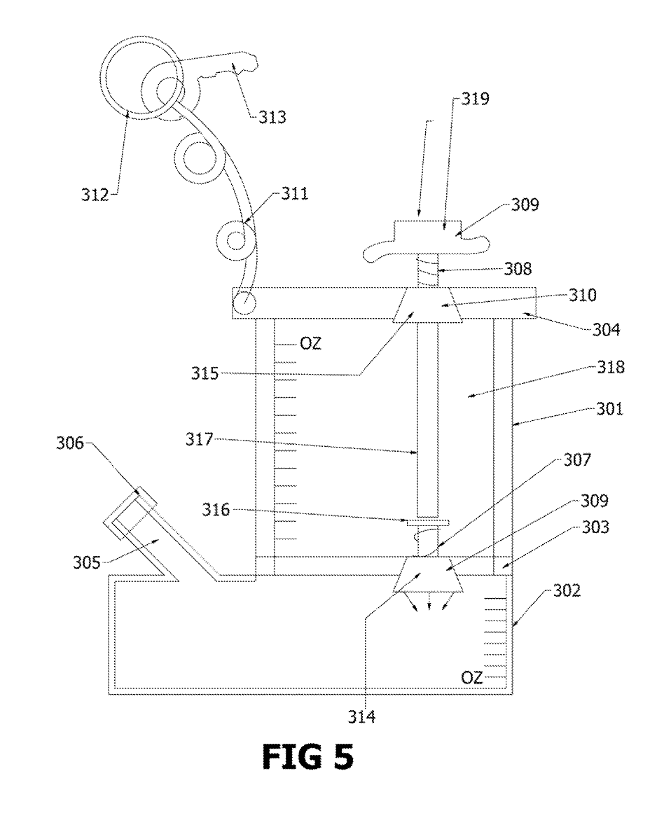

### MEANING OF THE TERMS

Fluid—any fluid that flows
Flowing matter—Any fluid or powder that flows by force of gravity
Powder—Any powder that flows with force of gravity
Container—Any bottle or jar or gas can or container of any sort
Enclosure—Any Cap or Lid or object above a container to at least partially cover the opening of a container
Channel—An elongated opening between 2 containers
Valve—Any style of valve that continuously closes and continuously opens the flow of fluids or powders in a channel.
Tapered channel—An elongated opening that has tapered sides
Tapered Plug—any object that stops the flow of a flowing matter from within a tapered channel
Poured—When a fluid or powder exits from an opening either by force or by gravity.
Flow—When a fluid or powder has a current within a channel by force of gravity.
Mixture, when 2 flowing matters either alike or dis-alike mix together.

### PRIOR ART

| PATETNT NO | DATE | INVENTOR |
|---|---|---|
| 1,332,985 | Jun-20 | E. S Jarrett |
| 2,385,648 | Jun-44 | M. Prager |
| 2,592,485 | Apr-50 | C. B Stair |
| 2,698,113 | Dec-54 | M. B. Linton |
| 2,848,997 | Aug-58 | Miskel et.al |
| 3,261,381 | Jul-66 | R. L. Roach |
| 3,290,017 | Dec-66 | H. K. Davies etal |
| 3,521,745 | Jul-70 | G. Schwartzman |
| 3,530,722 | Sep-70 | P. J. Miller |
| 3,548,562 | Dec-70 | G. Schwartzman |
| 4,979,941 | Dec-90 | G. B. Ogle |
| 5,078,289 | Jan-92 | Bolton et al |
| 5,108,016 | Apr-92 | waring |
| 5,255,812 | Oct-93 | Yu T. Hsu |
| 5,662,249 | Sep-97 | A. Grosse |
| 5,647,413 | Jul-97 | Robin H |
| 6,022,134 | Feb-00 | C. L. Andrews |
| 6,079,405 | Jun-00 | J. justo |
| 6,109,487 | Aug-00 | masaya |
| 6,705,462 | Mar-04 | Shoji Kasuya |
| 6,705,491 | Mar-04 | E. lizerbaum |
| 20050040052 | | B. Dixon |
| 20100044377 | | John porter |
| 7,980,131 | Jul-11 | Barton |
| 8,011,534 | Jun-11 | Roth et all |
| 8,499,971 | Aug-13 | Roth et al |
| 20140335234 | | Conopco inc. |
| 9,149,808 | Oct-15 | Smith et al |
| 9,310,238 | Apr-16 | Joseph |
| 9,347,812 | May-16 | Holms et al |

1-19. (canceled)

20. A measuring and dispensing apparatus comprising of a container having an upper portion and a lower portion, said container at least partially filled with a fluid and partially with air where said air is above the said fluid, at least one valve with an open and close position and a channel in communication with said one valve, and when the said one valve is in open position, 1st the air from outside of the said container mixes with the said air in the inside of the said container thru an opening from the said lower portion without contacting the lower surface of the liquid, and said liquid flows out of the said channel by the force of gravity.

21. The lower portion of container of claim 1 further is in communication with a plate where said plate is fasten to the upper portion of a 2^{nd} container, and said fluid enters inside of the 2^{nd} container.

22. The plate of claim 21 further is the said lower portion.

23. The upper portion of 2^{nd} container of claim 21 further is large enough to accept at least a third container.

24. The container of claim 1, further comprising of at least one measuring mark.

25. The valve of the claim 1 further comprising of a tapered channel and a tapered plug and said tapered plug is plugging the said taper channel and said plug is coupled to a control mechanism and said control mechanism comprising of a biasing member and said biasing member presses the said plug against the inner walls of the said channel to prevent the flow of the said fluid thru the said channel.

26. The plug of claim 4 further is long enough to exceed above the upper surface of the said fluid and when the said plug is unbiased, the said outside air mixes with the said inside air.

27. The channel of claim 4 further includes an opening where said opening is below the upper surface of said liquid and said opening is in contact with said fluid and when the biasing member is unbiased, the said fluid exits from the said container thru the said opening.

28. The container of claim 1 further comprising of a 2nd channel and a 2^{nd} valve, and the said 2^{nd} valve in communication with a 3^{rd} channel and said 3^{rd} channel having 2 ends, where one end is extended above the said inside air, and when the said 1^{st} valve opens, the 2^{nd} valve opens and the said outside air mixes with the said inside air thru the 3^{rd} channel.

29. The fluid of claim 1 further comprising of a percentage of Capsaicin.

30. The fluid of claim 1 further comprising of 2 cycle oil.

31. The fluid of claim 1 further comprising of a percentage of hair coloring compound.

32. The fluid of claim 1 further comprising of medical solutions.

33. The top portion of the plate of claim 2 further comprising of multiple coupling mechanism to accept multiple containers.

34. The container of claim 1 further is used to store water or cleaning solutions or gasoline.

35. The container of claim 1 further comprising of a mechanism that hangs from a key chain.

36. The container of claim 1 further comprising of a twist on cap that resembles a Hat.

37. A measuring and dispensing apparatus comprising of a container for fluids, and a 1^{st} ball valve and a 2^{nd} ball valve with an open and a close position, said 1^{st} ball valve and said 2^{nd} ball valve coupled together, said 1^{st} ball valve in communication with a channel extending above the surface of said fluid and when said 1^{st} ball valve is in open position the 2^{nd} ball valve automatically opens, and 1^{st}, outside air only comes in contact with the upper surface of said fluid thru the said 1^{st} ball valve and the said fluid exits from the said container thru the 2^{nd} ball valve.
